(19) United States
(12) Patent Application Publication
(10) Pub. No.: US 2014/0129207 A1
(43) Pub. Date: May 8, 2014

(54) Augmented Reality Language Translation

(71) Applicant: Apex Technology Ventures, LLC, Houston, TX (US)

(72) Inventors: Benjamin D. Bailey, Roswell, GA (US); Brannon C. McKay, Marietta, GA (US)

(73) Assignee: Apex Technology Ventures, LLC, Houston, TX (US)

(21) Appl. No.: 13/946,747

(22) Filed: Jul. 19, 2013

(51) Int. Cl. G06F 17/28; G10L 15/26

(52) U.S. Cl. CPC G06F 17/289; G10L 15/26
USPC 704/2

(57) ABSTRACT

Described herein are systems, devices, and methods for translating an utterance into text for display to a user. The approximate location of one or more potential speakers can be determined and a detected utterance can be assigned to one of the potential speakers based, at least in part, on a temporal relationship between the commencement of lip movement by one of the potential speakers and the reception of the utterance. The utterance can be converted to text and, if necessary, translated from a source language to a destination language. The converted text can then be displayed to the user in an augmented reality environment such that the user can intuitively appreciate to which of the potential speakers the converted text should be attributed.

### BACKGROUND OF THE DISCLOSURE

As international business dealings and travel become more and more prevalent, language barriers all too frequently interfere with the exchange of information between interested parties. Several speech-to-speech, speech-to-text, and text-to-speech translation systems and methods have been developed, but none provide the flexibility necessary to accommodate users in a sufficiently wide array of contexts and scenarios.

Most known translation systems comprise a microphone, a voice-to-text converter, a text-to-text translator, as well as a user display and/or a text-to-voice converter and speaker. In practice, a spoken source language is detected by the microphone. The audio signal can then be input to the voice-to-text converter where the spoken source language is converted to text in the source language. Next, the source text can be input to the text-to-text translator where the source text is converted to a destination language text.

The destination text can then be displayed to a user via a user display or other graphical interface. Alternatively, the destination text can be input to the text-to-voice converter where the destination text is converted back to an audio signal in the destination language. Finally, the destination language audio can be output to the user via a speaker.

Of course, other translation systems, including those that begin with source language text rather than spoken source language are also available, but the same general concepts apply.

Advancements in known systems and methods have primarily focused on the text-to-text translation from source text to destination text. Such advancements include the development of increasingly complex text recognition hypotheses that attempt to categorize the context of a particular utterance and, as a result, output a translation more likely to represent what the origin speaker intended. Other systems and methods rely on ever-expanding sentence/word/phrase libraries that similarly output more reliable translations. Many of these advancements, however, not only require increased processing power, but more complex user interfaces. Additionally, relatively few are configured for use by the hearing impaired.

Accordingly, current voice-to-text and voice-to-voice translation systems and methods could benefit from improved devices and techniques for collecting spoken source language, gathering contextual information regarding the communication, and providing an intuitive interface to a user.

### SUMMARY OF THE DISCLOSURE

In accordance with certain embodiments of the present disclosure, a system and method for presenting translated text in an augmented reality environment is disclosed. The system comprises a processor, at least one microphone, and optionally, at least one camera. In some embodiments, the camera can be configured to capture a user's field of view, including one or more nearby potential speakers. The microphone can be configured to detect utterances made by the potential speakers.

In one aspect, the processor can receive a video or image from the camera and detect the presence of one or more faces associated with the potential speakers in the user's field of view. The processor can further detect a lip region corresponding to each face and detect lip movement within the lip region.

In another aspect, the processor can assign detected utterances to a particular speaker based on a temporal relationship between the commencement of lip movement by one of the potential speakers and the commencement of the utterance.

In a further aspect, the processor can convert the utterance to text and present the text to the user in an augmented reality environment in such a way that the user can intuitively attribute the text to a particular speaker.

Additional objects and advantages of the present disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the claims.

The accompanying drawings, which are incorporated in and constitute a part of this specification, illustrate several embodiments and together with the description, serve to explain the principles of the disclosure.

### BRIEF DESCRIPTION OF THE DRAWINGS

FIG. 1 depicts some aspects of an exemplary embodiment of a system as described herein.

FIG. 2A-D depicts some aspects of exemplary embodiments of a system as described herein.

FIG. 3 depicts an exemplary embodiment of a computing system as described herein.

FIG. 4 depicts some aspects of an exemplary method as described herein.

FIG. 5 depicts some aspects of an exemplary method as described herein.

FIG. 6 depicts a flow chart depicting an exemplary sequence for a voice-to-text translation as described herein.

FIG. 7 depicts a flow chart depicting an exemplary sequence for presenting a translation to a user as described herein.

FIG. 8 depicts some aspects of an exemplary embodiment of a system as described herein.

FIG. 9 depicts some aspects of an exemplary method as described herein.

FIG. 10 depicts some aspects of an exemplary embodiment of a system as described herein.

### DESCRIPTION OF EXEMPLARY EMBODIMENTS

Disclosed herein are various embodiments of a voice-to-text translation system. Generally, the system can detect a spoken source language, convert the spoken source language to text, translate the source text to a destination language text, and display the destination language text to a user. Currently employed systems require complex user interfaces requiring multiple inputs or interactions on the part of one or both parties to a communication. Communicating in real-time, and in a manner that does not disrupt the natural flow of the conversation, is difficult due to the attention required by the translation system that necessarily detracts from the personal interaction between the communicating parties. Additionally, currently employed systems are not ideally suited for contexts in which more than two parties are communicating with one another, or in which at least one communicating party is hearing impaired.

The systems disclosed herein solve these problems by introducing elements of augmented reality into real-time language translation in such a way that the identity of a speaker and his or her proximate location can be intuitively demonstrated to the user. Moreover, in situations where three or more parties are participating in a conversation, the sequential flow of the conversation can be presented to a user in an intuitive manner that is easy to follow without detracting from the ongoing personal interactions.

While the systems and methods described herein are primarily concerned with voice-to-text translation, one skilled in the art will appreciate that the systems and methods described below can be used in other contexts, including voice-to-voice translation and text-to-text translation. Additionally, while the systems and methods described herein focus on the translation from a source language to a destination language, one skilled in the art will appreciate that the same concepts apply to situations in which the user is hearing impaired and only a voice-to-text conversion may be necessary.

Reference will now be made in detail to certain exemplary embodiments, examples of which are illustrated in the accompanying drawings. Wherever possible, the same reference numbers will be used throughout the drawings to refer to the same or like items.

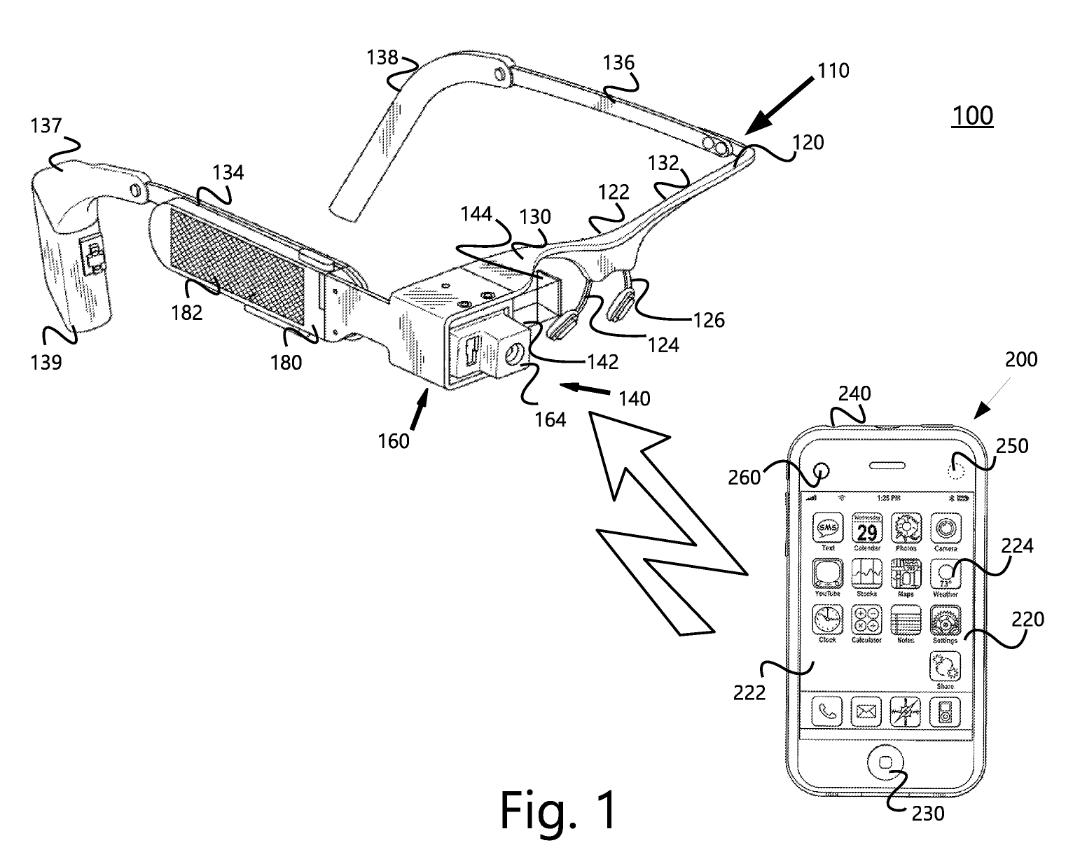

FIG. 1 illustrates one exemplary embodiment of a translation system 100. System 100 can comprise a display device 110 and a communication device 200. Both display device 110 and communication device 200 are configured for one or more of receiving, transmitting, and displaying information. In one embodiment, display device 110 can be a head-mounted display device configured to display an in-focus, near-eye image to a user. In other embodiments, display device 110 can be any near-eye display device configured to display an image to a user proximate to the user's eye. The depiction of a “head-mounted” or “wearable” device in FIG. 1 is exemplary only, and should not be construed to exclude other near-eye display devices that are not head-mounted or wearable.

In one embodiment, communication device 200 can be a processor-based smart phone. In other embodiments, communication device 200 can be any portable computing device such as a cell phone, a smart phone, a tablet, a laptop, or some other portable, processor-based device. In further embodiments, communication device 200 can be any other portable or non-portable processor-based device, such as a processor-based device built into a vehicle. The communication device 200 can also be built into display device 110.

In the embodiment depicted in FIG. 1, display device 110 and communication device 200 can be in communication with one another and configured to exchange information. Devices 110 and 200 can be in one-way or two-way communication, and can be wire- or wirelessly-connected. In some embodiments, devices 110 and 200 can communicate via a Bluetooth communication channel. In other embodiments, devices 110 and 200 can communicate via a RF or wi-fi communication channel. In further embodiments, devices 110 and 200 can communicate over some other wireless communication channel or a wired communication channel.

Though FIG. 1 depicts system 100 comprising display device 110 and communication device 200, other embodiments may comprise only display device 110 or only communication device 200. The depiction of devices 110 and 200 in the depicted embodiment should not be construed to exclude embodiments where only one of devices 110 or 200 is present. In further embodiments, one or both of devices 110 and 200 may be in communication with additional processor-based devices.

In one embodiment, display device 110 can comprise a frame 120, a display 140, a receiver 160, and an input device 180. In one aspect, frame 120 can comprise a bridge portion 122, opposing brow portions 130, 132, and opposing arms 134, 136. In use, frame 120 is configured to support display device 110 on a user's head or face. Bridge portion 122 can further comprise a pair of bridge arms 124, 126. In this manner, bridge portion 122 can be configured for placement atop a user's nose. In one embodiment, bridge arms 124, 126 can be adjusted longitudinally and/or laterally in order to achieve customizable comfort and utility for the user. In other embodiments, bridge arms 124, 126 are static or can only be adjusted longitudinally or laterally.

Opposing brow portions 130, 132 can extend from opposite ends of bridge portion 122 and span a user's brow. Similarly, arms 134, 136 can be coupled to the outer ends of respective brow portions 130, 132 and extend substantially normal or perpendicular therefrom so as to fit around the side of a user's head. In some embodiments, arms 134, 136 terminate in ear pieces 137, 138 that can serve to support frame 120 on the user's ears. Ear pieces 137, 138 may also contain a battery 139 to provide power to various components of display device 110. In one embodiment, battery 139 is a suitable type of rechargeable battery. In other embodiments, battery 139 is some other suitable battery type.

Frame 120, including bridge portion bridge portion 122, opposing brow portions 130, 132, and opposing arms 134, 136 can be made of any suitable material. In one embodiment, bridge portion 122, brow portions 130, 132, and opposing arms 134, 136 are made of a metal or plastic material. In other embodiments, the constituent portions of frame 120 can be made of some other suitable material. In further embodiments, bridge portion 122, brow portions 130, 132, and opposing arms 134, 136 are each made of one or more suitable materials.

In one aspect, bridge portion 122, opposing brow portions 130, 132, and opposing arms 134, 136 can be fixedly coupled to one another. In other embodiments, one or more of the constituent portions of frame 120 can be rotatably or otherwise moveably coupled with respect to adjoining portions in order to allow frame 120 to foldably collapse for portability, storage, and/or comfort. In another aspect, one or more portions of frame 120 may be solid or hollow in order to house wired connections between various components of display device 110.

Display 140, receiver 160, and input device 180 can each be mounted to frame 120. In one embodiment, display 140 and receiver 160 can be mounted at one end of brow portion 130. In alternative embodiments, display 140 and receiver 160 can be mounted at some other portion of frame 120 and/or at different portions of frame 120. As depicted in FIG. 1, display device 110 can comprise a single display 140. In other embodiments, display device can comprise a pair of displays 140, one located proximate to each of the user's eyes.

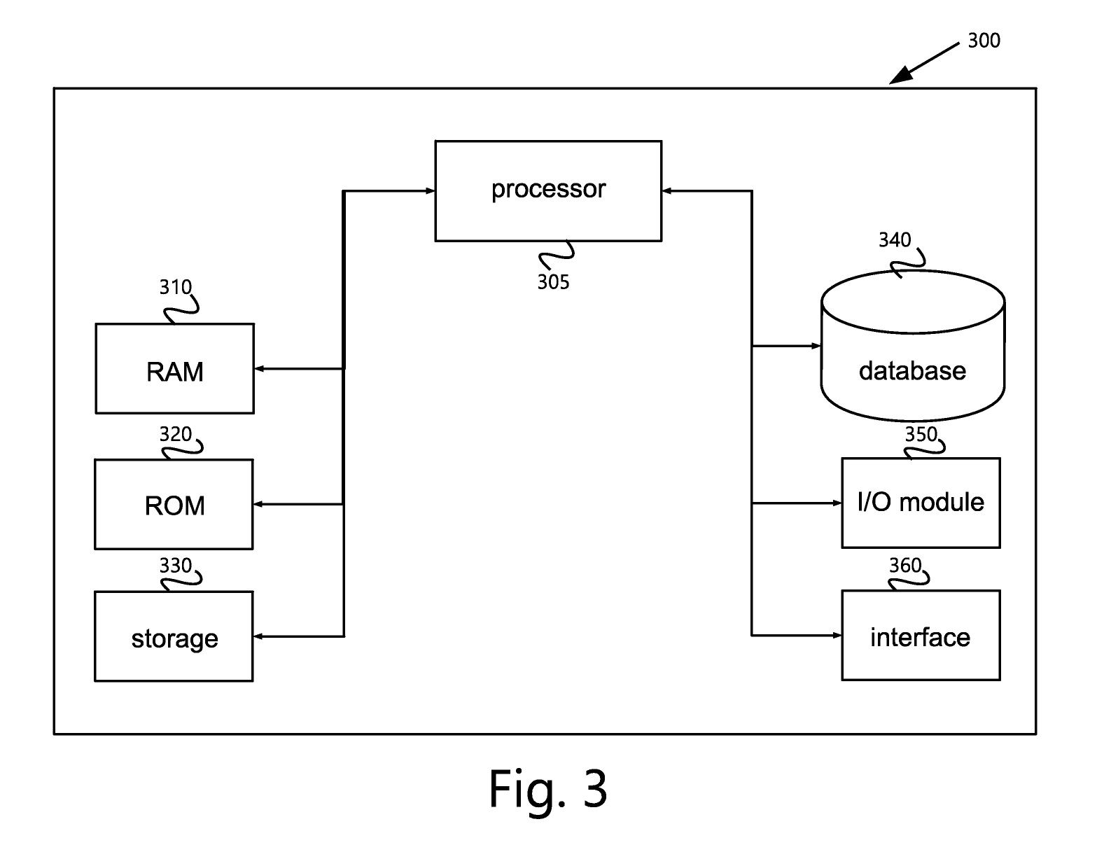

Receiver 160 can comprise an on-board computing system 162 (not shown) and a video camera 164. In one aspect, on-board computing system 162 can be wire- or wirelessly-connected to other components of display device 110, such as display 140, input device 180, camera 164, and/or projector 142. In another aspect, on-board computing system 162 can comprise a processor and memory, and may be configured to send, receive, and analyze data to and from other components of display device 110. On-board computing system 162 may be further configured to send, receive, and analyze data to and from other devices, for example, communication device 200. Various components of one exemplary embodiment of the on-board computing system are depicted in FIG. 3.

Video camera 164 can be positioned on brow portion 130 or arm 134 of frame 120. In other embodiments, video camera 164 can be positioned elsewhere on frame 120. In one aspect, video camera 164 can be any suitable camera configured to capture still images and video at one or more resolutions and/or frame rates. In another aspect, video camera 164 is a forward facing camera so as to capture images and video representative of what a user is seeing or facing. Further, video camera 164 can be in communication with receiver 160 and on-board computing system 162 such that images or video captured by camera 164 can be transmitted to receiver 160. Likewise, information can also be transmitted to camera 164 from receiver 160.

In the embodiment depicted in FIG. 1, display device 110 comprises a single, front-facing camera 164. In alternative embodiments, display device 110 may comprise multiple cameras 164, one or more of which may be rear-facing so as to capture still images or video of the user's face or subjects located behind the user. For example, display device 110 may comprise a rear-facing camera directed substantially at the location of a user's eye such that the camera can detect the general direction in which the user is looking or whether the user's eye is in an open or closed state. This information can then be transmitted to receiver 160 for use in applications where information about the user's eye direction or eye state may be desirable.

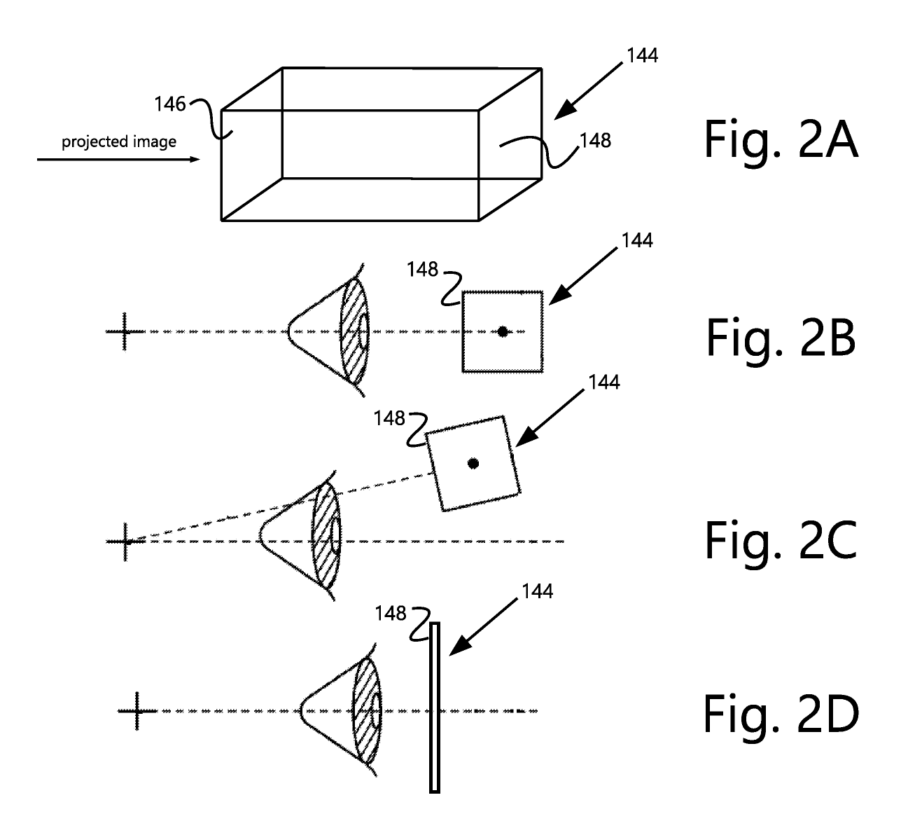

Video and images captured by camera 164, after being transmitted to on-board computing system 162, can be transmitted to display 140. In one embodiment, display 140 can comprise a projector 142 and a viewing prism 144, as well as other electronic components. In one aspect, video and/or images transmitted from on-board computing system 162 can be received by projector 142. Projector 142 can then project the received video or images onto a receiving surface 146 of prism 144. Prism 144 can be configured in such a way to reflect the images projected onto receiving surface 146 onto viewing surface 148 of prism 144 in such a way that the images are visible to the user by looking into viewing surface 148. FIG. 2A depicts a view of prism 144, receiving surface 146, and viewing surface 148.

In another aspect, prism 144 can be transparent and, as a result, the appearance of images and/or video on viewing surface 148 may not block the user's field of vision. In this manner, video or images presented on viewing surface 148 can afford display device 110 augmented reality functionality, superimposing images and video over the user's field of view.

In one embodiment, projector 142 can include an image source such as an LCD, CRT, or OLED display, as well as a lens for focusing an image on a desired portion of prism 144. In other embodiments, projector 142 can be some other suitable image and/or video projector.

In another aspect, additional electronic components of display 140 can comprise control circuitry for causing projector 142 to project desired images or video based on signals received from the on-board computing system 162. In a further aspect, the control circuitry of display 140 can cause projector to project desired images or video onto particular portions of receiving surface 146 of prism 144 so as to control where a user perceives an image in his or her field of view.

In a further aspect, prism 144 and projector 142 can be translationally and rotatably coupled within display 140. Further, prism 144 and projector 142 may be configured to translate and rotate independent of one another and in response to commands received from the control circuitry of display 140 and/or on-board computing system 162. In one embodiment, projector 142 comprises a cylindrical shaft that mates with a cylindrical recess in prism 144. This configuration enables prism 144 to rotate with respect to a user's eye and, as a result of altering the angle of viewing surface 148 with respect to the user's eye, move an image displayed to the user on surface 148 of prism 144 up and down within the user's field of view, as depicted in FIGS. 2B and 2C.

In another aspect, prism 144 and/or projector 142 can be coupled within display 140 or to frame 120 in such a manner so as to allow prism 144 and/or projector 142 to translate with respect to frame 120. In this manner, prism 144 and/or projector 142 can translate with respect to frame 120, and as a result, move an image displayed to the user on surface 148 of prism 144 left and right within the user's field of view.

In use, prism 144 can be positioned such that a user can comfortably perceive viewing surface 148. In one embodiment, prism 144 can be located beneath brow portion 130 of frame 120. In other embodiments, prism 144 can be located elsewhere. For example, prism 144 can be positioned directly in front of a user's eye. Alternatively, prism 144 can be positioned above or below the center of the user's eye. Additionally, prism 144 can be positioned to the left or the right of the center of the user's eye. Moreover, in some embodiments, the position of prism 144 with respect to frame 120, and thus, the user's eye can be adjusted so as to change the positional relationship between the user's eye and an image displayed on viewing surface 148.

In one embodiment, and as depicted in FIG. 2A, prism 144 can be a hexahedron having six faces comprising three pairs of opposing rectangular surfaces. In other embodiments, prism 144 may exhibit some other shape comprising rectangular and square surfaces. In further embodiments, prism 144 can exhibit some other shape. Prism 144 can also be comprised of any suitable material or combination of materials. Regardless of the shape or composition of prism 144, prism 144 can be configured such that receiving surface 146, located proximate projector 142, can receive an image from projector 142 and make that image visible to a user looking into viewing surface 148. In some embodiments, receiving surface 146 is substantially perpendicular to viewing surface 148 such that a transparent prism can be used to combine the projected image with the user's field of view, and thus, achieve augmented reality functionality. In other embodiments, receiving surface 146 and viewing surface 148 may be at some other angle with respect to one another that is greater than or less than ninety degrees. In further embodiments, prism 144 can be opaque or semi-transparent.

In still further embodiments, display 140 may comprise a substantially flat lens 144 as depicted in FIG. 2D rather than a prism. In such embodiments, projector 142 can be located near a viewing surface 148 of the lens and/or positioned such that a viewable image can be projected directly onto viewing surface 148 of lens 144, rendering the image visible to the user.

Returning to FIG. 1, in another aspect of display device 110, input device 180 can be mounted to frame 120 at arm 134 so as to overlay a portion of the side of a user's head. In alternative embodiments, input device 180 can be mounted to frame 120 in other locations. In particular, input device 180 can be located at any portion of frame 120 so as to be accessible to a user by feel rather than sight.

Input device 180 can comprise a touchpad 182 for sensing a position, pressure, or movement imparted by a user's finger via capacitive sensing, resistance sensing, or a surface acoustic wave process, among other possibilities. In one aspect, touchpad 182 can be configured to sense finger movement in a direction parallel, planar, or perpendicular to touchpad 182. In another aspect, touchpad 182 can exhibit a textured surface so as to provide tactile feedback to a user when the user's finger contacts the surface. In this manner, the user can easily identify the location of touchpad 182 despite not being able to see the touchpad when display device 110 is in use. In alternative embodiments, touchpad 182 can be subdivided into two or more portions, each dedicated to receiving user inputs. In this manner, touchpad 182 can be configured to receive a variety of commands from the user. The different portions of touchpad 182 can be demarcated using a variety of textural or tactile elements to inform the user as to which portion the user is currently touching and when the user moves his or her finger from one portion to another without requiring a visual inspection by the user.

Input device 180, like display 140, can be configured to wire- or wirelessly-communicate with receiver 160 and on-board computing system 162. In one embodiment, any input received at touchpad 182 through contact with the user can be transmitted to receiver 160 and commands can be relayed to camera 164, display 140, or any other components of display device 110.

In addition to display device 110, FIG. 1 further depicts communication device 200. In one aspect, communication device 200 can be configured to wire- or wirelessly-communicate with display device 110. For example, communication device 200 and display device 110 may communicate via a Bluetooth communication channel. In other embodiments, devices 200 and 110 can communicate via a RF or wi-fi communication channel. In further embodiments, devices 200 and 110 can communicate over some other wireless communication channel or a wired communication channel.

In another aspect, communication device 200 can be a processor-based smart phone. In alternative embodiments, communication device 200 can be any portable computing device such as a cell phone, a smart phone, a smart watch, a tablet, a laptop, or some other portable, processor-based device. In further embodiments, communication device 200 can be any other portable or non-portable processor-based device, such as a desktop personal computer or a processor-based device built into a vehicle (e.g., a plane, train, car, etc.).

In still further embodiments, communication device 200 is equipped with all components necessary to accomplish the methods and processes described herein. In such embodiments, display device 110 may not be necessary and system 100 may comprise only communication device 200. In other embodiments, system 100 may comprise communication device 200 and one or more devices other than display device 110.

As depicted in FIG. 1, communication device 200 can comprise a computing system 210 (not shown), a graphical display 220, a menu button 230, a microphone 240, a rear-facing camera 250, and a forward-facing camera 260. In alternative embodiments, communication device 200 can comprise fewer than all of the aforementioned components. In other embodiments, communication device 200 can comprise additional components not expressly listed above.

In one aspect, computing system 210 can be wire- or wirelessly-connected to other components of communication device 200, such as graphical display 220, menu button 230, microphone 240, rear-facing camera 250, and/or forward-facing camera 260. In another aspect, computing system 210 can comprise a processor and memory, and may be configured to send, receive, and analyze data to and from other components of communication device 200. Computing system 210 may be further configured to send, receive, and analyze data to and from other devices, for example, display device 110. Various components of one exemplary embodiment of computing system 210 are depicted in FIG. 3.

A user can control the functionality of communication device 200 through a combination of user input options. For example, a user can navigate various menus and functions of communication device 200 using display 220 which can comprise a touchscreen 222. In one embodiment, touchscreen 222 may be configured for sensing a position, pressure, tap, or movement imparted by a user's finger via capacitive sensing, resistance sensing, or a surface acoustic wave process, among other possibilities. In one aspect, touchscreen 222 can be configured to sense finger movement in a direction parallel, planar, or perpendicular to touchscreen 222. Additionally, a user may input commands to communication device 200 by pressing or tapping menu button 230.

Display 220 may further depict one or more icons 224 representing applications that communication device 200 may be configured to execute. A user can select, configure, navigate, and execute one or more of the applications using any combination of inputs via touchscreen 222, menu button 230, and/or some other input component(s). A user may also download new or delete existing applications using the same combination of input components.

In another aspect, communication device 200 can comprise one or more microphones 240 configured to detect sounds and utterances in the vicinity of communication device 200. Such sounds or utterances may include ambient (or background) noise, as well as the voice of nearby speakers. Sounds detected by the one or more microphones can then be transmitted to computing system 210 for further processing.

In a further aspect, communication device 200 can comprise one or more cameras. For example, in one embodiment, communication device 200 can comprise a rear-facing camera 250 and a forward-facing camera 260. In one aspect, cameras 250, 260 can be any suitable camera configured to capture still images and video at one or more resolutions and/or frame rates. In particular, rear-facing camera 250 may be configured so as to capture images and video representative of what a user is seeing or facing. Moreover, rear-facing camera 250 can be in communication with computing system 210 such that images or video captured by rear-facing camera 250 can be transmitted to computing device 210 for further processing. Likewise, information can also be transmitted to rear-facing camera 250 from computing system 210. Before, during, or after being transmitted to computing device 210, any images or video captured by rear-facing camera 250 can be transmitted to display 220 for presentation to the user. For example, video captured by rear-facing camera can be transmitted to display 220 for presentation to the user in real-time.

Likewise, forward-facing camera 260 may be configured so as to capture images and video of the user's face or subjects located behind the user. For example, forward-facing camera 260 can be configured to detect the user's eyes, the general direction in which the user is looking, and/or whether the user's eyes are in an open or closed state. This information can then be transmitted to computing system 210 for suitable applications during which the user's eye direction or eye state may be desirable. Moreover, forward-facing camera 260 can be in communication with computing system 210 such that images or video captured by forward-facing camera 260 can be transmitted to computing device 210 for further processing. Likewise, information can also be transmitted to forward-facing camera 260 from computing system 210. After being transmitted to computing device 210, any images or video captured by forward-facing camera 260 can be transmitted to display 220 for presentation to the user.

In the embodiment depicted in FIG. 1, communication device 200 comprises a single rear-facing camera 250 and a single forward-facing camera 260. In alternative embodiments, communication device 200 may comprise additional cameras, both rear- and forward-facing.

FIG. 3 depicts an exemplary processor-based computing system 300 representative of the on-board computing system 162 of display device 110 and/or computing system 210 of communication device 200. For the sake of clarity, where computing system 300 is referenced in this disclosure, it should be understood to encompass on-board computing system 162 of display device 110, computing system 210 of communication device 200, and/or the computing system of some other processor-based device.

In particular, system 300 may include one or more hardware and/or software components configured to execute software programs, such as software for storing, processing, and analyzing data. For example, system 300 may include one or more hardware components such as, for example, processor 305, a random access memory (RAM) module 310, a read-only memory (ROM) module 320, a storage system 330, a database 340, one or more input/output (I/O) modules 350, and an interface module 360. Alternatively and/or additionally, system 300 may include one or more software components such as, for example, a computer-readable medium including computer-executable instructions for performing methods consistent with certain disclosed embodiments. It is contemplated that one or more of the hardware components listed above may be implemented using software. For example, storage 330 may include a software partition associated with one or more other hardware components of system 300. System 300 may include additional, fewer, and/or different components than those listed above. It is understood that the components listed above are exemplary only and not intended to be limiting.

Processor 305 may include one or more processors, each configured to execute instructions and process data to perform one or more functions associated with system 300. As illustrated in FIG. 3, processor 305 may be communicatively coupled to RAM 310, ROM 320, storage 330, database 340, I/O module 350, and interface module 360. Processor 305 may be configured to execute sequences of computer program instructions to perform various processes, which will be described in detail below. The computer program instructions may be loaded into RAM for execution by processor 305.

RAM 310 and ROM 320 may each include one or more devices for storing information associated with an operation of system 300 and/or processor 305. For example, ROM 320 may include a memory device configured to access and store information associated with system 300, including information for identifying, initializing, and monitoring the operation of one or more components and subsystems of system 300. RAM 310 may include a memory device for storing data associated with one or more operations of processor 305. For example, ROM 320 may load instructions into RAM 310 for execution by processor 305.

Storage 330 may include any type of storage device configured to store information that processor 305 may need to perform processes consistent with the disclosed embodiments.

Database 340 may include one or more software and/or hardware components that cooperate to store, organize, sort, filter, and/or arrange data used by system 300 and/or processor 305. For example, database 340 may include user-specific account information, predetermined menu/display options, and other user preferences. Alternatively, database 340 may store additional and/or different information.

I/O module 350 may include one or more components configured to transmit information between the various components of display device 110 or communication device 200. For example, I/O module 350 may facilitate transmission of data between touchpad 182 and projector 142. I/O module 350 may further allow a user to input parameters associated with system 300 via touchpad 182, touchscreen 222, or some other input component of display device 110 or communication device 200. I/O module 350 may also facilitate transmission of display data including a graphical user interface (GUI) for outputting information onto viewing surface 148 of prism 144 or graphical display 220. I/O module 350 may also include peripheral devices such as, for example, ports to allow a user to input data stored on a portable media device, a microphone, or any other suitable type of interface device. I/O module 350 may also include ports to allow a user to output data stored within a component of display device 110 or communication device 200 to, for example, a speaker system or an external display.

Interface 360 may include one or more components configured to transmit and receive data via a communication network, such as the Internet, a local area network, a workstation peer-to-peer network, a direct link network, a wireless network, or any other suitable communication platform. For example, interface 360 may include one or more modulators, demodulators, multiplexers, demultiplexers, network communication devices, wireless devices, antennas, modems, and any other type of device configured to enable data communication via a communication network.

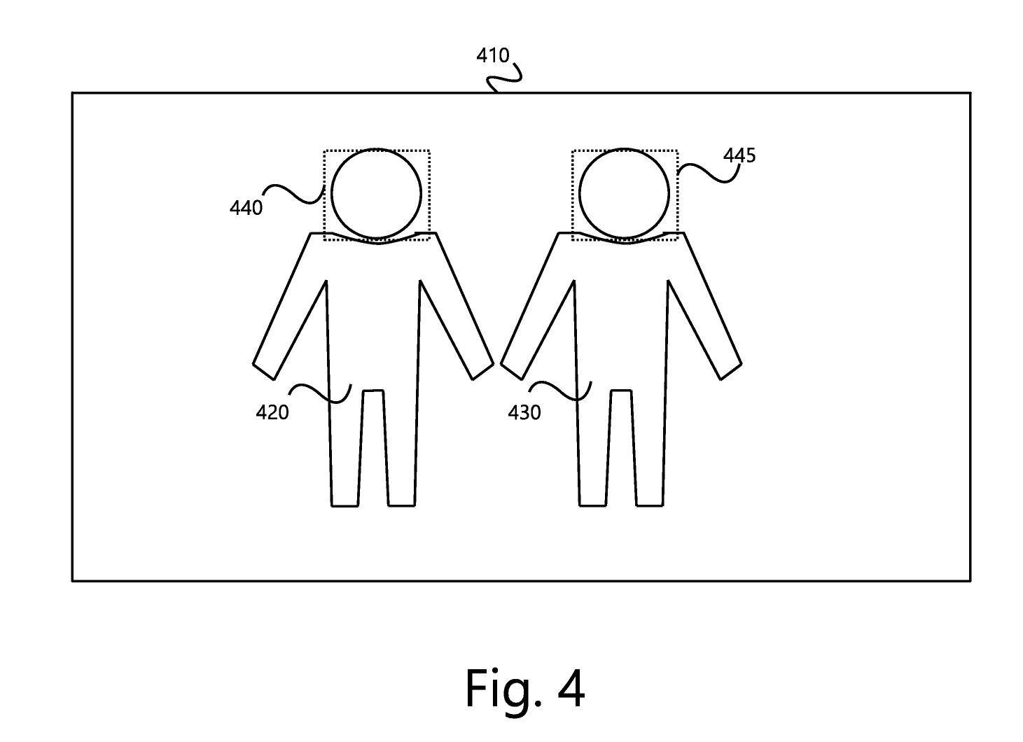

FIG. 4 depicts aspects of an exemplary method for recognizing the position of faces within an image or video. First, frame 410 may be provided. Frame 410 may be a still image captured by a camera of display device 110, communication device 200, or some other device. Alternatively, image 410 may be one or more frames of an on-going video captured by a camera of display device 110, communication device 200, or some other device.

Frame 410 can be transmitted to one or both of on-board computing system 162 of display device 110 and computing system 210 of communication device 200. In other embodiments, frame 410 may be transmitted to another computing system. In another aspect, frame 410 may then be transmitted to one or both of display 140 of display device 110 and graphical display 220 of communication device 200 for presentation to the user. In alternative embodiments, frame 410 can be presented to the user on another display. In further embodiments, rather than transmitting frame 410 to a display for presentation to the user, the frame can be stored in memory or a database associated with the aforementioned computing system.

In one embodiment, a facial detection algorithm may then be performed on frame 410 by computing system 300 in order to detect the presence of one or more faces belonging to potential speakers 420, 430. In some embodiments, the facial detection may be conducted pursuant to the standard Viola-Jones boosting cascade framework. In such an embodiment, frame 410 can be scanned with one or more sliding windows. A boosting cascade classifier can then be employed on Haar features in order to determine if one or more faces is present in image or frame 410. Many facial detection processes are known and description of the Viola-Jones boosting cascade framework here should not be construed as limiting the present description to that process. Any suitable facial detection process can be implemented. For example, in other embodiments, the Schneiderman & Kanade's method or the Rowley, Baluja & Kanade's method can be used. In further embodiments, another method can be used.

In another aspect, the facial recognition algorithm can further detect the lip region of each detected face and distinguish the lip region from other regions of each detected face. The aforementioned facial recognition methods or one of several other known methods may be used to detect and/or identify the lip region(s). In the context of this disclosure, any suitable method of facial and/or lip region detection can be implemented.

In a further aspect, in instances where frame 410 is being presented to the user in real-time or will be presented to the user at a later time, computing system 300 can identify the presence of one or more faces in frame 410 and transmit information to display 140 or display 220 causing the placement of a visual indicator in frame 410 marking the location of the identified faces. For example, in one embodiment, computing system 300 can transmit information causing the presentation of boxes 440, 445 around the location of one or more faces detected in frame 410. In this manner, a user presented with frame 410 and boxes 440, 445 can quickly identify which faces in frame 410 have been detected by computing system 300. In alternative embodiments, computing system 300 can transmit information causing the presentation of some other visual indicator identifying the location of detected faces. In further embodiments, computing system 300 may not transmit information for causing the presentation of a visual indicator identifying the location of detected faces to the user.

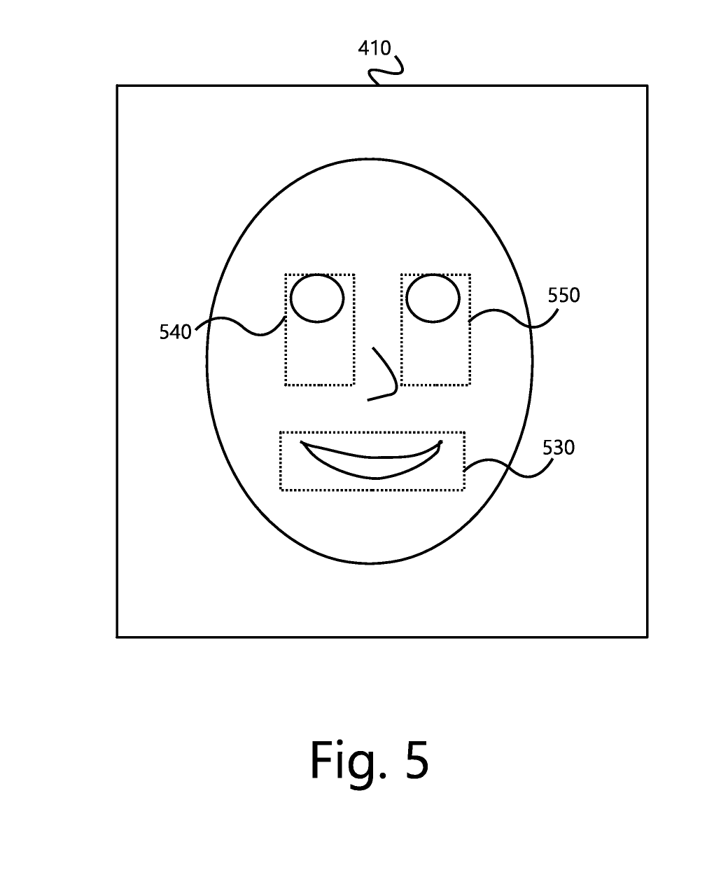

FIG. 5 depicts aspects of detecting lip movement in an identified face. This can be accomplished using several known methods, including the comparison of optical flow in a lip region 530 compared to a non-lip region 540. For example, after lip region 530 and non-lip region 540 have been identified as previously discussed with respect to facial detection methods, a determination can be made as to the magnitude of optical flow in these regions. Optical flow is the apparent motion of brightness patterns in an image. Generally, optical flow corresponds to the motion field. As a result, a ratio of the magnitude of optical flow in lip region 530 and the magnitude of optical flow in non-lip region 540 can be monitored and compared to a predetermined threshold value indicative of relative movement.

Determining the magnitude of optical flow in lip region 530 and/or non-lip region 540 can be accomplished using any suitable method. In one embodiment, the magnitude of optical flow in a region can be determined using a third level Pryamidal Lucas-Kanade optical flow method. In other embodiments, a phase correlation method, block-phase method, Horn-Schunk method, Buxton-Buxton method, Black-Jepson method, or a discrete optimization method can be used. In further embodiments, some other suitable method can be used.

In FIG. 5, non-lip region 540 corresponds to a cheek area of a detected face. In some embodiments, other non-lip regions can be used, such as a forehead region. In further embodiments, more than one non-lip region can be monitored and used for detecting the magnitude of non-lip regions of a detected face. For instance, non-lip regions 540 and 550, both corresponding to cheek regions, can be used. In alternative embodiments, a non-lip region other than cheek regions 540, 550 can be used. For example, a forehead region can be used. In still further embodiments, any combination of one or more non-lip regions can be monitored for determining the magnitude of optical flow in non-lip regions of a detected face. Where multiple non-lip regions are monitored, a mean value for the magnitude of the optical flow can be established and used in the aforementioned ratio.

If the ratio of the magnitude of optical flow in lip region 530 to the magnitude of optical flow in non-lip region(s) exceeds the predetermined threshold, it can be concluded that lip movement is present in the detected face. Alternatively, if the ratio of the magnitude of optical flow in lip region 530 to the magnitude of optical flow in non-lip region(s) is less than the predetermined threshold, it can be concluded that no lip movement is present in the detected face.

The aforementioned method of detecting lip movement is exemplary only. Any other suitable method for detecting lip movement in a facial image can be used in the context of this disclosure.

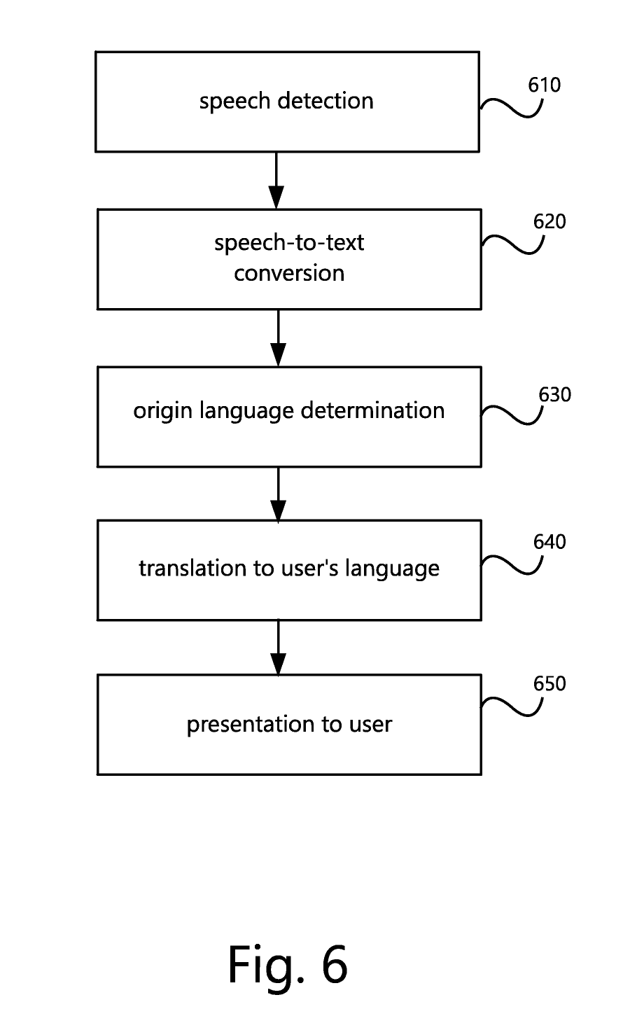

FIG. 6 depicts one exemplary method for translating spoken source language to destination language text. In one aspect, at step 610, an utterance in a source language is detected or captured by a microphone. In one embodiment, microphone 240 of communication device 200 can capture an utterance in the source language. In other embodiments, a microphone component of display device 110 or some other microphone can capture an utterance in a source language.

At step 620, the captured utterance is transmitted from the microphone by which it was captured to computing system 300. For example, the utterance may be transmitted in the form of a digital or analog signal to computing system 210 of communication device 200. Alternatively, the utterance may be transmitted to on-board computing system 162 of display device 110. In further embodiments, the utterance may be transmitted to some other computing system. The computing system may then process the received utterance and convert the received signal to text in the source language. Many known methods for converting detected audio to text exist and any suitable method of conversion may be implemented in the context of this disclosure.

Once the captured audio has been converted to text in the source language, computing system 300 can identify the source language at step 630 using known methods. In one embodiment, text categorization is used to identify the source language. For example, the Nearest-Neighbour model, the Nearest-Prototype Model, or the Naïve Bayes model may be used to identify the source language. In alternative embodiments, a support vector machine (SVM) method or a kernel method can be utilized. In further embodiments, any suitable method for identifying the language of a text string can be implemented in the context of this disclosure and the aforementioned examples should not be construed as limiting.

In another aspect of the method depicted in FIG. 6, after the source language has been identified, the source text can be translated into destination language text at step 640. In one embodiment, the destination language is predetermined. For example, the user of communication device 200 and/or display device 110 may pre-select the destination language by inputting a selection to computing system 300 via any suitable input component. In alternative embodiments, communication device 200 and/or display device 110 may learn the user's native language by monitoring the text and speech inputs of the user. Such learning can be performed using any of the aforementioned language identification models, as well as any other suitable method.

Translation of the source language text to the destination language text can also be performed using any suitable, known method. In some embodiments, pattern recognition and/or speech hypotheses can be used with or without a supplemental database containing predetermined translations between the source language and the destination language. In alternative embodiments, other known methods of text-to-text language translation can be used.

At step 650, the destination language text resulting from step 640 can be presented to the user. In one embodiment, the destination language text is displayed to the user on display 140 of display device 110 using projector 142 and prism 144. In an alternative embodiment, the destination language text can be displayed to the user on graphical display 220 of communication device 200. In further embodiments, the destination language text can be displayed to the user on some other display. In still further embodiments, the destination language text can be displayed to the user on multiple displays, including, but not limited to display 140 of display device 110 and graphical display 220 of communication device 200.

In another aspect, the destination language text can be displayed to the user in any location at which the user can read the output text such that the initial source language utterance can be understood.

In additional embodiments, the destination language text can be converted to an audio signal in the destination language and output to the user via a speaker. In such embodiments, the conversion from text to speech is performed using the same methods used to convert the source language utterance to text, in reverse. Alternatively, any suitable, known method of converting text to speech can be used in the context of this disclosure. The resulting audio signal can be transmitted from computing system 300 to a speaker that is either wire- or wirelessly-connected to communication device 200 or display device 110 for output to the user. In other embodiments, the resulting audio can be transmitted to another speaker that may or may not be a component of communication device 200 or display device 110.

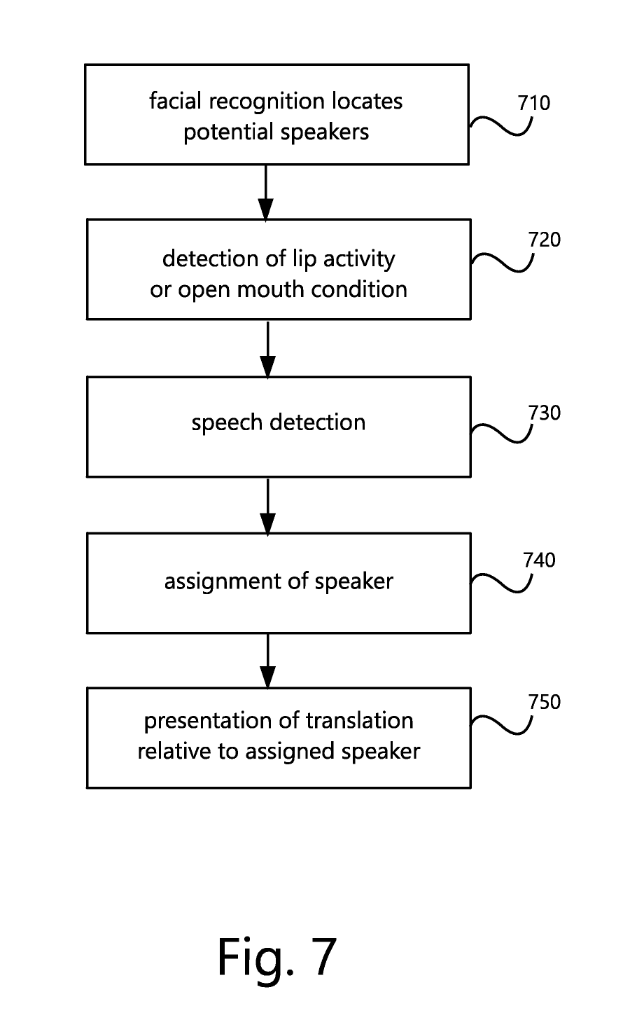

FIG. 7 depicts one exemplary method for identifying the relative position or location of the speaker of the utterance captured in the source language. In one aspect, camera 164 of display device 110 or rear-facing camera 250 of communication device 200 can continuously capture video of the user's environment, including any potential speakers in the user's vicinity. In one embodiment, the user can capture video of potential speakers by directing camera 164 or rear-facing camera 250 towards any potential speakers. In alternative embodiments, another camera may be used.

At step 710, frames of the captured video may be transmitted to computing system 300 to be continuously processed or processed at predetermined intervals in order to detect the presence and location of faces within the frame/video. In one embodiment, such facial detection can be performed as discussed above with respect to FIG. 4. In other embodiments, facial detection can be performed using any suitable method. Additionally, lip region detection can also be performed on the transmitted frame/video by computing system 300.

In a further aspect, the video captured by camera 164, camera 250, or some other camera can be transmitted via computing system 300 to a display for presentation to the user. In one embodiment, captured video can be transmitted and presented to the user at display 140 of display device 110. Alternatively, captured video can be transmitted and presented to the user at graphical display 220 of communication device 200. In further embodiments, captured video can be transmitted and presented to another display viewable by the user.

Where computing system 300 has identified the presence of one or more faces in the captured frame/video, computing system 300 can transmit information to display 140 or display 220 causing the placement of a visual indicator to overlay the captured video being transmitted to display 140 or display 220, indicating the location of the identified faces. For example, as discussed above, computing system 300 can transmit information causing the presentation of boxes 440, 445 around the location of one or more faces detected in the captured frame/video that is being displayed to the user. In this manner, the overlaid visual indicators (e.g., boxes 440, 445) achieve augmented reality functionality and intuitively identify the location of potential speakers to the user in real-time.

At step 720, lip movement detection can be performed with respect to any or all faces identified in the captured video. The lip movement detection can be performed using any of the methods discussed above with respect to FIG. 5. For example, lip movement detection can be performed through a comparison of the magnitude of optical flow in a lip region of an identified face and a non-lip region in the same identified face. In alternative embodiments, the lip movement detection can be performed using any suitable, known method.

At step 730, an utterance in a source language is detected or captured by a microphone, as discussed above with respect to step 610 in FIG. 6. In one embodiment, microphone 240 of communication device 200 captures the utterance in the source language. In other embodiments, a microphone component of display device 110 or some other microphone can capture the utterance in the source language.

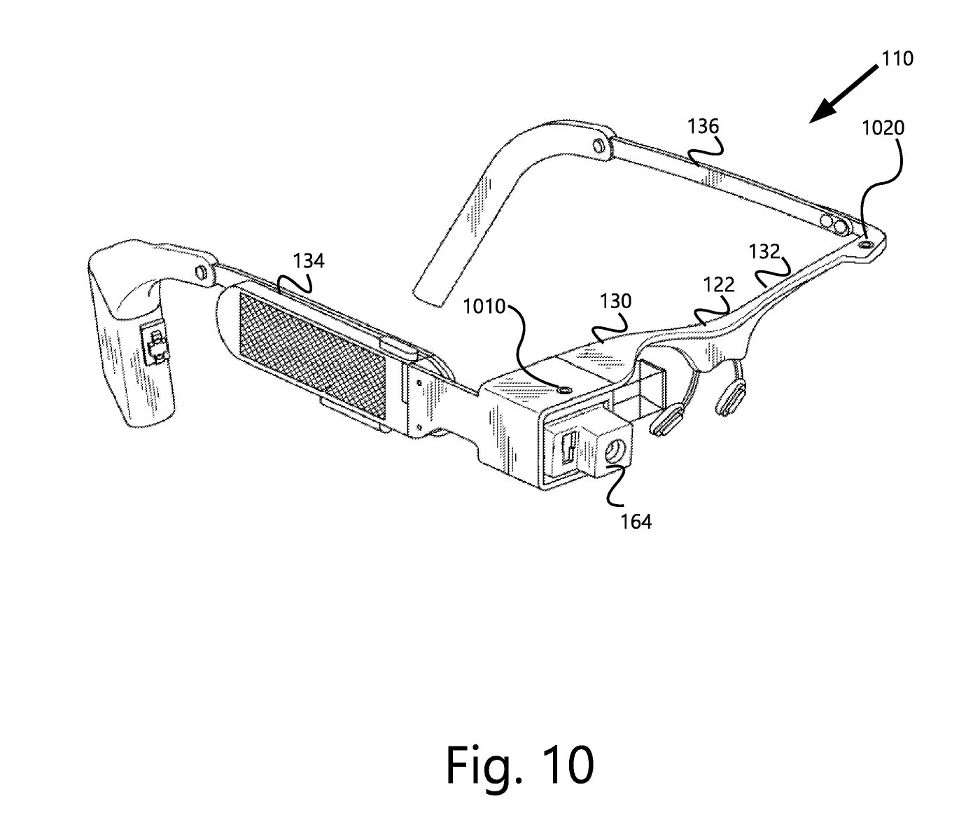

In an alternative embodiment, for example as discussed below in reference to FIG. 10, display device 110 may comprise multiple microphones that can be used to spatially locate the utterance based on which microphone receives the utterance first and/or more loudly. A time delay between the utterance being detected by left and right microphones may also be computed by processor 305, on-board computing device 162, or some other processor. Based on that time delay in view of the speed of sound and/or a difference in sound threshold levels between the left and right microphones, an estimate may be established regarding the source of that sound relative to the user rather than relying on the detection of lip movement in step 720. Alternatively, this estimate can be compared by computing device 300 to the lip movement detection of step 720 to further corroborate or determine the speaker during step 740.

At step 740, computing device 300, having either detected the commencement of lip movement in one of the identified faces of the captured video in temporal relationship or substantial synchronicity with the commencement of a source language utterance, can accurately attribute the captured utterance to the face in which the lip movement has commenced. In one aspect, computing device 300 can determine which of the subjects in captured video is speaking and the relative position of that speaker within the captured video.

At step 750, computing device 300 can transmit destination language text, representing a translation of the source language utterance, to a display for presentation to the user. In one embodiment, computing device 300 can transmit destination language text for display to the user as described above with respect to step 650 of FIG. 6. For example, the destination language text can be displayed to the user on display 140 of display device 110 using projector 142 and prism 144. In an alternative embodiment, the destination language text can be displayed to the user on graphical display 220 of communication device 200. In further embodiments, the destination language text can be displayed to the user on some other display.

In another aspect, the destination language text is displayed to the user overlaying the real-time video being presented to the user. In this manner, the destination language text achieves augmented reality functionality within the captured video. In one embodiment, the destination language text can be displayed at a position within the captured video relative to the location of the face determined to be the speaker of the source language utterance (i.e., the assigned speaker). For example, the destination language text can be displayed at a position immediately adjacent to the location of the face of the assigned speaker. In other embodiments, the destination language text can be displayed in some other position relative to the assigned speaker, including but not limited to above the face of the assigned speaker, overlaying the face of the assigned speaker, or below the face of the assigned speaker. As a result, the user viewing the captured video with the overlaid destination language text can read the destination language text and intuitively understand who is responsible for the original source language utterance being translated. This feature can be particularly important in situations where the user is conversing with multiple foreign language speakers that are alternating between speaking roles in a conversational manner.

In some embodiments, the destination language text can be color-coded such that utterances from one speaker within the video are displayed in a first color and utterances from another speaker within the video are displayed in a second color. Further, any overlaid visual indicators (e.g., square boxes) indicating the location of a potential speaker's face can be presented in a color corresponding to the color of the destination language text attributable to that speaker.

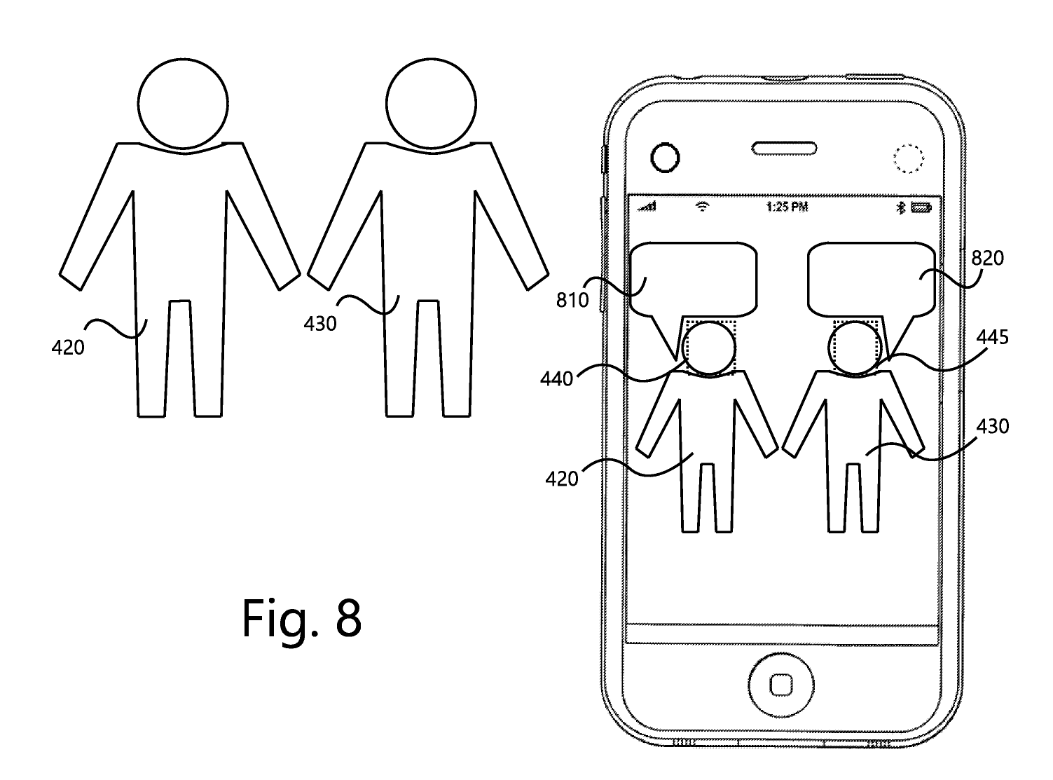

FIG. 8 depicts an exemplary system in use. In one aspect, communication device 200 can be used to accomplish the methods described above with respect to FIGS. 6 and 7. Communication device 200 can comprise graphical display 220, microphone 240, and rear-facing camera 250, among other components.

In another aspect, a user can configure or prepare communication device for translation by launching one or more appropriate applications and/or navigating relevant menus using a combination of inputs entered using touchscreen 222 and menu button 230. Of course, these input components are exemplary only and any combination of one or more input components can be used to prepare communication device 200 for translation.

Once prepared for translation, the user can direct rear-facing camera 250 toward one or more potential speakers 420, 430. Camera 250 can transmit captured video to computing system 300 for detection of faces within frames of the video, detection of lip regions within the detected faces, and detection of non-lip regions within the detected faces. As described above, camera 250 and computing system 300 can also be configured to detect the commencement of lip movement by any of the detected faces.

In one embodiment, computing system 300 can process video captured by camera 250 and detect the presence of faces corresponding to the potential speakers 420, 430. FIG. 8 depicts two potential speakers, but it should be understood that the systems and methods described herein are equally applicable to situations involving only one potential speaker, as well as situations involving more than two potential speakers. Computing system 300 can also continuously monitor the detected faces for the commencement of lip movement. Alternatively, computing system 300 can check for the commencement of lip movement at predetermined intervals.

In another aspect, computing system 300 can transmit the video captured by camera 250 to graphical display 220 for presentation to the user in real-time. Computing system 300 can also cause one or more visual indicators, such as boxes 440, 445, to be displayed on graphical display 220 such that the visual indicators overlay any faces detected in the captured video.

When a subject captured in the video from camera 250 begins to speak, lip movement by that subject can be detected by computing system 300 and the source language utterance from that subject can be captured by microphone 240. The temporal relationship or substantial synchronicity between the lip movement and the detection of an utterance can enable computing system 300 to determine which subject in the captured video is responsible for speaking the utterance.

The captured source language utterance can then be converted into text, translated into destination language text, and then presented to the user on graphical display 220 of communication device 200, as described with respect to FIGS. 6 and 7. In particular, the destination language text can be displayed to the user at a location proximate the location of the assigned speaker's face. In this manner, the user can intuitively determine the speaker of the destination language text presented on display 220. In the embodiment depicted in FIG. 8, the destination language text can be presented substantially above the assigned speaker (or speaker responsible for the source language utterance to which the destination language text is associated). However, in alternative embodiments, the destination language text can be presented at some other location relative to the assigned speaker.

Thus, in practice, destination language text 810 associated with an utterance made by potential speaker 420 can be displayed to the user on graphical display 220 at a position proximate visual indicator 440 (i.e., the location of the face of potential speaker 420). Similarly, destination language text 820 associated with an utterance made by potential speaker 430 can be displayed to the user on graphical display 220 at a position proximate visual indicator 445 (i.e., the location of the face of potential speaker 430).

In other embodiments, destination language texts 810 and 820, as well as visual indicators 440 and 445 can be color coded such that destination language text 810 and visual indicator 440 appear in the same, first color while destination language text 820 and visual indicator 445 appear in a different, second color. In an alternative embodiment, computing system 300 can cause destination language text to appear within a “bubble” on graphical display 220. In such embodiments, the bubbles rather than the destination language text may be color coded in concert with visual indicators 440 and 445.

It should be appreciated that while the embodiment depicted in FIG. 8 comprises communication device 200 and does not require display device 110, other embodiments are possible that involve both communication device 200 and display device 110 wire- or wirelessly-communicating. Further embodiments are also envisioned that comprise display device 110, but do not require communication device 200.

In embodiments comprising display device 110, video captured from a suitable camera, visual indicators representative of the location of potential speakers' faces, and destination language text can be presented to the user via display 140. In particular, projector 142 can project the relevant images on prism 144. Moreover, the location of the images presented to the user can be positioned within the user's field of view by controlling where on receiving surface 146 of prism 144 that projector 142 projects images. In other embodiments, the location of images presented to the user can be positioned within the user's field of view by controlling the location of prism 144 with respect to the user's eye and/or the orientation of prism 144 with respect to the user's eye. In other words, images to be presented to the user can be moved up, down, left, and right within the user's field of view as discussed previously herein. In further embodiments, images to be presented to the user can be positioned within the user's field of view through a combination of projector and prism controls.

In embodiments comprising display device 110, video captured from camera 164 or some other camera may not be displayed to the user. In such embodiments, the video may be used to identify the location of potential speakers within the user's field of view, detect the presence of faces, and detect the commencement of lip movement. Once the utterances captured by a wire- or wirelessly-connected microphone are converted to text and translated to a destination language text, the destination language text can be presented to the user on prism 144 via projector 142 in such a manner that while the user is observing the potential speakers through transparent prism 144, the destination language text can be displayed on viewing surface 148 of prism 144 and superimposed on the user's field of view. In particular, the destination language text can be displayed on viewing surface 148 of prism 144 and superimposed on the user's field of view thereby achieving augmented reality functionality and allowing the user to intuitively determine the speaker of a textual utterance, in a manner described above.

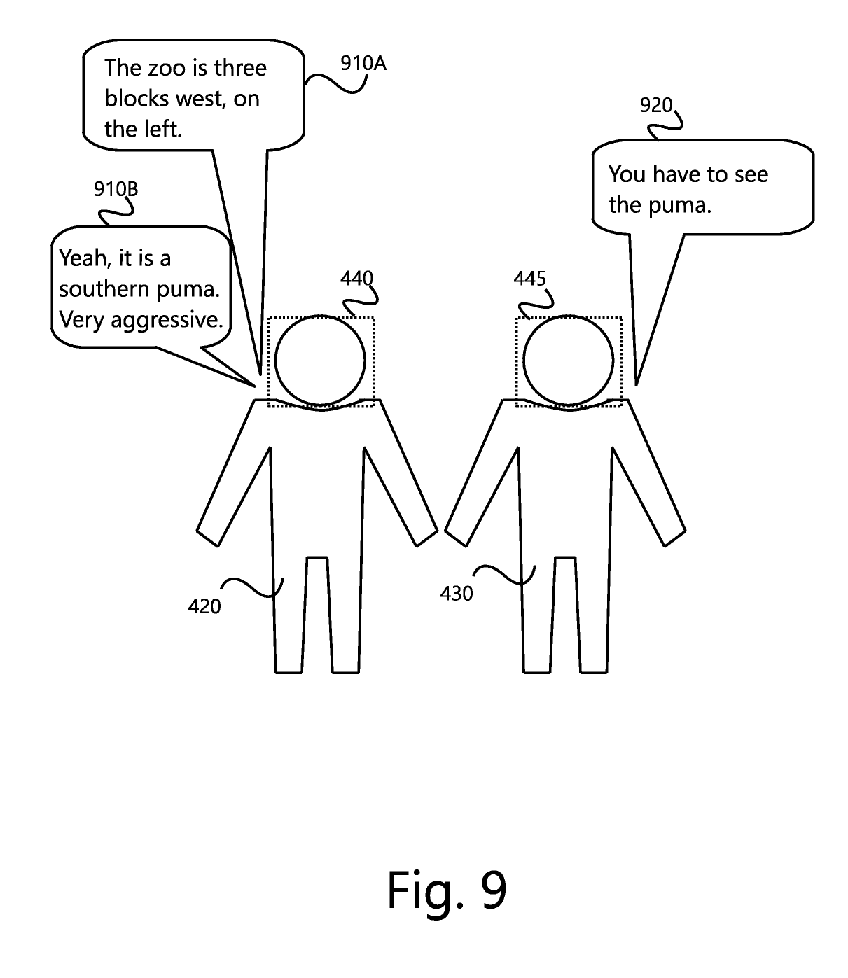

FIG. 9 depicts chronological features of the present systems and methods. In one aspect, the relative position of destination language text as it is presented to the user can be indicative of when utterances corresponding to the destination language text were made. In one embodiment, older destination language text may appear to scroll upward toward the top of a display viewable by the user. In such an embodiment, the oldest visible text may appear to scroll out of view while text associated with the most recent utterances appears below and/or proximate an assigned speaker's face. In other embodiments, the position of text associated with the utterances of a first speaker 420 with respect to the position of text associated with the utterances of a second speaker 430 may also be chronologically indicative. For example, text 920 associated with an utterance by second speaker 430 may be displayed below text 910A associated with an utterance by first speaker 420 where the utterance associated with text 910A preceded the utterance associated with text 920. On the other hand, text 920 associated with the utterance by second speaker 430 may be displayed above text 910B associated with an utterance by first speaker 420 where the utterance associated with text 920 preceded the utterance associated with text 910B.

In further embodiments, where bubbles or destination language text is color coded as described above, text associated with older utterances can begin to lighten or darken in color. Alternatively, text associated with older utterances can fade out of sight. In still further embodiments, any combination of text scrolling, lightening, darkening, fading, or undergoing some other graphical change can be used to further serve to indicate the flow of the conversation and the presence of text associated with more recently captured utterances.

Thus, the user can intuitively understand and follow the flow of a conversation despite the fact that multiple speakers are conversing in a foreign language. Of course, the positional relationships of the destination language text described above, as well as the appearance of such text, are exemplary only. The present disclosure envisions a variety of suitable methods for presenting destination language text in one or more positions, colors, and forms that allow the user to intuitively follow a conversation and accurately determine who is saying what, as well as when they are saying it.

FIG. 10 depicts another embodiment of display device 110. In one aspect, display device 110 as depicted in FIG. 10 is substantially similar to display device 110 as depicted in FIG. 1 and functions in substantial accordance therewith.

In another aspect, however, display device 110 may comprise one or more microphones configured to detect sounds and utterances in the vicinity of display device 110. Such sounds or utterances may include ambient (or background) noise, as well as the voice of nearby speakers. In one embodiment, display device 110 can comprise a pair of microphones 1010 and 1020. As depicted in FIG. 10, microphones 1010 and 1020 are positioned at opposite ends of brow portions 130 and 132, substantially near the respective couplings with arms 134 and 136. In other embodiments, microphones 1010 and 1020 can be located at alternative locations on display device 110. Further, while FIG. 10 depicts two microphones 1010, 1020, other embodiments may comprise a single microphone or more than two microphones. In particular, multiple microphones may be positioned in an array on one or more portions of display device, including but not limited to bridge portion 122, brow portions 130, 132, and arm portions 134, 136.

In a further aspect, the presence of multiple microphones can be used in conjunction with video of potential speakers captured by camera 164 in order to determine where to position destination language text within a user's field of view. For instance, camera 164 and on-board computing system 162 can be used to detect the presence of faces within a user's field of view, as described above with respect to other embodiments. However, rather than (or in addition to) monitoring the detected faces for lip movement occurring in temporal relationship or substantial synchronicity with the detection of an utterance in order to assign a speaker to the detected utterance, the capturing of the utterance by multiple microphones at slightly different times can be used to triangulate the relative position of the speaker.

For instance, as depicted in FIG. 10, display device 110 can comprise microphone 1010 positioned substantially over the user's right eye and microphone 1020 positioned substantially over the user's left eye. Where a pair of potential speakers are positioned before the user as they are in FIG. 8, utterances made by the potential speaker on the user's left should reach microphone 1020 before they reach microphone 1010. Conversely, utterances made by the potential speaker on the user's right should reach microphone 1010 before they reach microphone 1020. As a result, on-board computing device 162, which has already detected the faces (and therefore presence) of the two potential speakers, and having received information as to the time at which both microphones received the utterance, can determine which potential speaker made the utterance. The destination language text can then be assigned to the appropriate speaker and displayed to the user proximate the assigned speaker's face, as discussed previously.

In addition to analyzing and using a delay between microphones 1010 and 1020, a difference in volume amplitudes between microphones may also be utilized to identify the speaker. For example, if the volume is greater for the same utterance(s) at microphone 1020 than at microphone 1010, this may indicate that the speaker is positioned to the user's left more so than the user's right. Thus, in this example, if multiple potential speakers are in front of the user, it is more likely that one of the speakers on the user's left made the utterance than a speaker on the user's right. In one aspect, microphones 1010 and 1020 may be positioned close to the user's ears, such as proximate to the portions of display device 110 that rest over the user's ears when the display device 110 is worn. In this way, the delay and volume differential may be even more dramatic and useable for spatial recognition purposes.

In still a further aspect, computing system 300 may analyze the timbre characteristics of utterances (e.g., tone color and texture characteristics unique to each human voice). Computing system 300 may initially associate analyzed timbre characteristics with a speaker determined through other techniques described herein. Subsequently, when those timbre characteristics are recognized again, computing system 300 can use this association to attribute the new utterances with the previously-associated speaker. For example, if two individuals are speaking at once or if a potential speaker's lips are obstructed from view, computing system 300 may still identify the correct speaker based at least in part on timbre characteristics. In addition or in the alternative, pitch characteristics, such as the register of the speaker, may be stored along with the timbre to help identify a speaker. If the same timbre and/or pitch characteristics are not recognized within a predetermined time period, such as 15 minutes, computing system 300 may optionally delete the characteristics from memory.

The timbre characteristics analyzed, stored, and identified by computing system 300 may include formants. Formants may include areas of emphasis or attenuation in the frequency spectrum of a sound that are independent of the pitch of the fundamental note but are found always in the same frequency ranges. They are characteristic of the tone color (i.e., timbre) of each sound source. In one embodiment, the formants are identified as spectral peaks of the sound spectrum of the voice. Computing system 300 may identify them in one aspect by measuring an amplitude peak in the frequency spectrum of an utterance through spectral analysis algorithms. Other timbre characteristics may include a fundamental frequency of the utterance, and a noise character of the utterance.

In one aspect, computing system 300 can monitor both audio streams from microphones 1010 and 1020 for matches in utterances that are synchronized with lip movement recognition. If lip movement is detected on multiple faces at once, then one or more of these audio comparison techniques may be used to determine which of the potential speakers is speaking.

In another alternative embodiment, rather than using facial recognition algorithms to detect the location of potential speakers within the user's field of view, detection and assignment of potential speakers' location relative to the user can be accomplished entirely through audio algorithms for triangulation, timbre analysis, and/or other location-identifying methods that employ one or more microphones and analyze one or more of the intensity, direction, and timing of detected utterances.

All the embodiments described above can be used to detect a source language utterance, convert the utterance to text, translate the source language text to a destination language text, and display the destination language text to a user in a manner that the user can intuitively appreciate who is speaking and the chronology of a conversation among two or more participants. A method of use can comprise the provision of one or more of the devices described above, including but not limited to display device 110 and communication device 200.

Additional features can also be incorporated into the described systems and methods to improve their functionality. For example, display device 110 and/or communication device 200 can be configured to store past conversations in an associated database such that a user can recall and review earlier conversations. In other embodiments, the captured source language audio can also be stored and associated with the relevant past conversation such that the audio can be played back and/or the translations can be verified. In such embodiments, display device 110 and/or communication device 200 may be further configured to wire- or wirelessly-transmit the video and/or audio of one or more conversations to another device. In a further embodiment, source language text converted from a source language utterance can be stored in an associated database such that it can be recalled and/or presented to the assigned speaker. In this manner, the assigned speaker can verify that the translation being provided to the user accurately reflects the captured utterance.

Other embodiments will be apparent to those skilled in the art from consideration of the specification and practice of this disclosure. It is intended that the specification and examples be considered as exemplary only, with the true scope and spirit of the disclosure being indicated by the following claims.

What is claimed is:

1. A translation system for converting an utterance to text, the system comprising:
a camera for capturing one or more frames comprising one or more potential speakers;
a microphone for capturing an utterance; and
a processor configured to detect the position of the one or more potential speakers with respect to a user and assign one of the potential speakers to the utterance;
wherein the processor is further configured to convert the captured utterance to text and transmit the converted text to a display for superimposing the converted text over the user's field of view at a position relative to the assigned speaker's position within the user's field of view.

2. The translation system of claim 1, wherein the position of the one or more potential speakers is detected by detecting a face corresponding to each potential speaker.

3. The translation system of claim 1, wherein the assignment of one of the potential speakers to the utterance is based, at least in part, on a temporal relationship between a detected lip movement associated with one of the potential speakers and the capture of the utterance.

4. The translation system of claim 1, wherein the display comprises a near-eye display.

5. The translation system of claim 4, wherein the display comprises a transparent lens or prism.

6. The translation system of claim 1, wherein the converted text is displayed within the user's field of view at a position relative to previously-displayed text associated with an earlier utterance that preceded the captured utterance.

7. The translation system of claim 1, wherein the relative position of the converted text within the user's field of view changes as text associated with a later utterance that succeeds the captured utterance is displayed within the user's field of view.

8. A translation system for presenting translated text to a user, the system comprising:
a camera configured to capture one or more images;
a microphone configured to capture an utterance;
a processor configured to detect the position of a face within the one or more images and translate the utterance from a source language to a destination language text; and
a display configured to display the one or more images and the destination language text, the destination language text being positioned relative to the detected face.

9. The translation system of claim 8, wherein the processor is further configured to detect a plurality of faces within the one or more images.

10. The translation system of claim 9, wherein the processor is further configured to detect the commencement of lip movement associated with one or more of the plurality of faces.

11. The translation system of claim 10, wherein the processor is further configured to assign one of the plurality of faces to the captured utterance based, at least in part, on detecting commencement of lip movement within one of the plurality of faces.

12. The translation system of claim 8, wherein the processor is configured to convert the captured utterance to source language text and translate the source language text to the destination language text.

13. The translation system of claim 11, wherein the destination language text is displayed proximate to the assigned detected face.

14. A non-transitory, computer-readable medium containing instructions that, when executed by a processor, perform a method comprising:
receiving video comprising one or more potential speakers;
receiving a first utterance made by one of the potential speakers;
assigning the first utterance to a first speaker of the potential speakers;
converting the first utterance to first text;
transmitting the video for display to a user; and
transmitting the first text for display to the user such that the first text is superimposed over the video at a position relative to the position of the first speaker within the video.

15. The non-transitory, computer-readable medium of claim 14, wherein assigning the first utterance to the first speaker comprises:
detecting a location of a face associated with the first speaker within the video;
detecting commencement of lip movement associated with the first speaker; and
assigning the first utterance to the first speaker based, at least in part, on a substantial synchronicity between the detected lip movement associated with the first speaker and the reception of the first utterance.

16. The non-transitory, computer-readable medium of claim 14, further comprising:
receiving a second utterance made by one of the potential speakers;
assigning the second utterance to a second speaker of the potential speakers;
converting the second utterance to second text; and
transmitting the second text for display to the user such that the second text is superimposed over the video at a position relative to the position of the second speaker within the video.

17. The non-transitory, computer-readable medium of claim 16, further comprising:
receiving a third utterance made by one of the potential speakers;
assigning the third utterance to the first speaker;
converting the third utterance to third text; and
transmitting the third text for display to the user such that the third text is superimposed over the video at a position relative to both the position of the first speaker and the position of the first text within the video.

18. The non-transitory, computer-readable medium of claim 17, wherein the first text and the third text are displayed in the same color, and the first text and the second text are displayed in different colors.

19. The non-transitory, computer-readable medium of claim 14, wherein assigning the first utterance to the first speaker comprises:
identifying a formant in the first utterance; and
matching the identified formant to a previously-stored formant associated with the first speaker.

20. The non-transitory, computer-readable medium of claim 17, wherein receiving the first utterance comprises receiving the first utterance in a first audio stream and a second audio stream detected by a first microphone and a second microphone, respectively; and
wherein assigning the first utterance to the first speaker is based at least in part on an audio triangulation using the first and second audio streams.
